(19) United States
(12) Patent Application Publication
(10) Pub. No.: US 2004/0143053 A1
(43) Pub. Date: Jul. 22, 2004

(54) Process for preparing emulsion polymers

(76) Inventors: Richard Shu-Hua Wu, Fort Washington, PA (US); David Arthur Pierce, Warrington, PA (US); Owen Clifford Hallerud, Mt. Laurel, NJ (US)

Correspondence Address: ROHM AND HAAS COMPANY, PATENT DEPARTMENT, 100 INDEPENDENCE MALL WEST, PHILADELPHIA, PA, 19106-2399, US

(21) Appl. No.: 10/752,893

(22) Filed: Jan. 7, 2004

Related U.S. Application Data
(60) Provisional application No. 60/441,458, filed on Jan. 21, 2003.

(51) Int. Cl. C08K 3/00

(52) U.S. Cl. 524/556

(57) ABSTRACT

A method of preparing an emulsion polymer having a low residual monomer content, wherein the method includes the simultaneous addition of an oxidizing agent and a reducing agent to different locations on the process side of a heat exchanger is provided.

The present invention relates to a method of preparing an emulsion polymer having a low residual monomer content, the method including the simultaneous addition of an oxidizing agent and a reducing agent to different locations on the process side of a heat exchanger, which thereby acts as a combined polymer cooling vessel, and mixer.

Thermal initiation systems and redox initiator systems, including at least one oxidizing agent and at least one reducing agent, are advantageously used in the emulsion polymerization of ethylenically unsaturated monomers. Redox initiator systems are particularly useful where it is desired that the polymerization take place at temperatures lower than those at which conventional thermal initiation systems provide an effective level of free radical production, such as at temperatures below 85° C. However, the use of either type of initiator system in batch and semi-batch emulsion polymerization processes results in unreacted monomer in the emulsion polymer product. The presence of unreacted monomer in the final polymer product is undesirable for several reasons. Such monomers are volatile organic compounds (VOCs), which are often toxic, and tend to have strong odors which can usually be detected at extremely low levels, even as low as in the parts per million range. The level of unreacted monomer can be reduced by chemical chasing. By “chemical chasing” is meant herein the addition of chemicals that cause the unreacted monomers to polymerize. In conventional batch or semi-continuous emulsion polymerization processes, the amount of unreacted monomer in the reactor is reduced by the separate addition of reducing agents and oxidizing agents directly to the reactor. However, a disadvantage of adding additional reducing and oxidizing agent in this manner is that it does not result in the efficient reduction of levels of monomer and other volatile materials in the emulsion polymer. In order to prevent a runaway reaction, the reactor must generally be cooled to about 60° C. before the reducing agent and oxidizing agent can be added to the reactor. This need for cooling results in increased cycle time because it can take several hours to cool the reactor to the required temperature. A further disadvantage of adding the reducing agent and oxidizing agent in this manner is that, in order to avoid a low chasing efficiency, as well as a potential runaway reaction, the two agents must not be added to the reactor at the same time, which results in further increases in cycle time. Yet another disadvantage of adding the reducing agent and oxidizing agent to the reactor is that, due to the large size of the reactor, and the high viscosity of the emulsion polymer therein, it is difficult to achieve good mixing of the small quantities of reducing and oxidizing agent, relative to the substantially greater volume of polymer and remaining unreacted monomer, that is needed to reduce the level of unreacted monomer. Therefore, improved methods for reducing the level of unreacted monomer in emulsion polymers are desirable.

U.S. Pat. No. 6,353,087 discloses a process for removing volatile organic compounds from polymer dispersions by stripping, and optionally by chemical chasing prior to stripping. However, the patent does not disclose the simultaneous addition of the chemical chasing agents to different locations on the process side of a heat exchanger, which thereby acts as a combined polymer cooling vessel, and mixer.

Applicants have discovered an emulsion polymerization process having the improved features of a reduced cycle time, and resulting in an emulsion polymer product containing low levels of unreacted monomer, and/or low volatile organic compound levels. This is achieved by simultaneously adding a reducing agent and an oxidizing agent to different locations on the process side of a heat exchanger through which the emulsion polymer flows.

In a first aspect of the present invention, there is provided a method of preparing a polymer containing low residual monomer levels, comprising: (i) preparing an emulsion polymer having one or more modes, and containing residual monomer; (ii) providing a heat exchanger having a process side and a cooling side; (iii) flowing at least a portion of said emulsion polymer through said process side of said heat exchanger; (iv) initiating the polymerization of said residual monomer by simulteaneously feeding an oxidizing agent and a reducing agent to different locations on said process side of said heat exchanger; and (v) completing said polymerization reaction to produce an emulsion polymer having a reduced residual monomer level.

The method of the present invention is directed toward the preparation of an aqueous emulsion polymer containing low residual monomer levels. By “residual monomer level” is meant herein the amount of monomer in the emulsion polymer that has not been polymerized. The polymerization techniques used to prepare emulsion polymers are well know in the art. The polymerization is carried out by either a batch or a semi-continuous process. By “semi-continuous”, herein is meant that some of the reactants are charged to the reactor at the beginning of processing, and the remaining reactants are fed continuously as the reaction progresses, while some of the product is simultaneously withdrawn from the reactor. The polymerization process is carried out by first supplying to a single continuously stirred tank reactor the materials used in the polymerization. These materials include water, and at least one ethylenically unsaturated monomer, and optionally include an emulsifier, catalyst and/or a polymer seed. By “continuously stirred”, herein is meant the reactants are agitated during processing, providing mixing and creating a substantially uniform composition within the reactor. By “tank reactor”, herein is meant a vessel with inlet and outlet pipes, equipped with some means of agitation and provisions for heat transfer (for example a heating/cooling jacket, or external or internal heat exchangers), and which can accommodate either batch or continuous operations over wide ranges of temperatures and pressures. By “polymer seed”, herein is meant, a polymer composition whose particle size predefines the diameter of the polymer particles in the final product. This invention contemplates that the addition of water and monomer to the reactor may include the addition of the water followed by neat monomer, or the addition of water followed by a monomer emulsion, or the addition of a mixture of water and a small amount of monomer, followed by the addition of a monomer emulsion.

Suitable ethylenically unsaturated monomers include, for example, amides such as (meth)acrylamide, propenamide, dimethylacrylamide; esters such as methyl acrylate, ethyl acrylate, butyl acrylate, propyl acrylate, 2-ethylhexyl acrylate, hydroxyethyl acrylate, methyl methacrylate, hydroxyethyl methacrylate, hydroxymethyl acrylate, hydroxymethyl methacrylate, hydroxypropyl acrylate, hydroxypropyl methacrylate, allyl methacrylate, diallyl phthalate, 1,3-butylene glycol dimethacrylate, 1,6-hexanedioldiacrylate, vinyl acetate, vinyl proprionate, or other vinyl esters; nitriles such as acrylonitrile; and the like, and combinations of the foregoing. Other suitable ethylenically unsaturated monomers include vinyl monomers such as, for example, vinyl chloride, vinylidine chloride, vinyl acetate and N-vinyl pyrollidone, divinyl benzene; styrene or alkyl-substituted styrene, butadiene; and the like, and combinations of the foregoing. Examples of ethylenically unsaturated carboxylic acid monomers that are useful in this invention include acrylic acid, methacrylic acid, fumaric acid, crotonic acid, maleic acid, itaconic acid, and combinations of two or more such acids. Preferably, the ethylenically unsaturated carboxylic acid is acrylic acid. Preferably, a stabilizing monomer, such as an acid containing monomer is used to stabilize the emulsion polymer. Examples of specific stabilizing monomers include the monomers listed above as examples of ethylenically unsaturated carboxylic acid monomers.

The free radical polymerization of the above monomers is initiated by redox or thermal initiation processes. The redox initiation process utilizes a redox system. By “redox system” is meant herein an oxidizing agent and reducing agent combination that is effective to generate free radicals. Examples of suitable oxidizing agents include ammonium persulfate, alkali metal persulfates; perborates; peracetates; percarbonates; peroxides, for example hydrogen peroxide, cumene hydroperoxide, dibenzoyl peroxide, diacetyl peroxide, dodecanoyl peroxide, di-t-butyl peroxide, dilauroyl peroxide, bis(p-methoxy benzoyl) peroxide, t-butyl peroxy pivilate, and dicumyl peroxide; isopropyl percarbonate; di-sec-butyl peroxidicarbonate, and the like, and mixtures thereof. Examples of suitable reducing agents include alkali metal and ammonium salts of sulfur-containing acids such as sodium sulfite, bisulfite, metabisufite, thiosulfite, sulfide, hydrosulfide, or dithionite; sulfinic acids, such as alkylsulfinic acids, aryl sulfinic acids, and hydroxyalkyl sulfinic acids, and 2-hydroxy-2-sulfinatoacetic acid; amines such as ethanolamine; glycolic acid; glyoxylic acid hydrate; ascorbic acid; isoascorbic acid; lactic acid; glyceric acid; malic acid; tartaric acid and salts of the preceding acids, salts of the preceding acids, and the like, and mixtures thereof. Suitable thermal initiators are those which decompose or become active at the polymerization temperature. Examples of suitable thermal initiators include those compounds listed above as oxidizing agents.

Emulsifiers that are are suitable for use in the present invention include anionic, nonionic, and cationic surfactants, soap, and the like, which are stable at the pH of the latex. Examples of suitable emulsifiers include alkyl sulfates, alkyl sulfosuccinates, alkyl aryl sulfonates, α-olefin sulfonates, quaternary ammonium salts, amine salts, fatty or resin acid salts, nonyl or octyl phenol reaction products of ethylene oxide and the like. Examples of suitable surfactants include sodium lauryl sulfate, sodium sulfosuccinates such as sodium dimethylamyl sulfosuccinate, sodium dodecyl diphenyloxide disulfonate and the like. The amount of emulsifier present is sufficient to obtain an aqueous emulsion of the monomers.

Optional chain transfer agents include mercaptans such as the alkyl and/or aralkyl mercaptans. Examples of suitable chain transfer agents include n-octyl mercaptan, n-dodecyl mercaptan, t-octyl mercaptan, t-dodecyl mercaptan, tridecyl mercaptan, tetradecyl mercaptan, hexadecyl mercaptan and the like, and mixtures thereof.

Conditions are created in the reactor which cause polymerization to proceed. The reactor is usually initially heated to establish the desired reaction temperature for production of the polymer. The reaction temperature is typically maintained at a temperature lower than 100° C. throughout the course of the reaction to form the emulsion polymer. Preferred is a reaction temperature from 30° C. to 98° C., more preferably from 40° C. to 95° C. Cooling is utilized during the polymerization process to control the reaction temperature. Appropriate means of cooling the reactor include, for example, a reactor jacket, and/or use of a recyle loop which passes through an external heat exchanger. In one embodiment of the present invention, at least part of the cooling is performed by removing polymer from the reactor and feeding it through an external loop to a heat exchanger, and then returning the polymer to the reactor. The heat exchanger is cooled by a flow of cooling water or other coolant. The temperature of the water or coolant typically ranges from 8° C. to 35° C.

In cases where a unimodal polymer product is desired, the supply of materials used in the polymerization process is continued under the above-mentioned conditions. In cases where a bimodal polymer product is desired, after 5 to 95 percent, preferably 15 to 60 percent, of the reactor feeds have been charged to the reactor, a surfactant, or an emulsion polymer having a diameter different from that of the particles in the first polymer mode at that point in the reaction is added to the reactor to initiate the growth of a second polymer mode. By “bimodal polymer” is meant herein a polymer wherein at least 90 percent of the polymer is present in two populations of particle mode, wherein each mode has a different particle size. If additional modes are desired, subsequent charges of surfactant or emulsion polymer are used to create a multimodal polymer product. The supply of materials used in the unimodal, bimodal, or multimodal polymerization is continued under the above-mentioned conditions.

In one embodiment of the invention, the emulsion polymer is prepared by a batch process. In this embodiment, the supply of materials used in the polymerization process is continued until the reactor is full. The emulsion polymerization process is continued until the conversion of monomer to emulsion polymer is at least 60%, preferably at least 90%, and more preferably at least 95%, as determined, for example, by a gravimetric method or gas chromatography. At this time, the remaining monomer is reacted, reducing the amount of residual monomer in the emulsion polymer. The oxidizing and reducing agents are simultaneously fed to different locations on the process side of a heat exchanger in a reactor recycle stream. By “reactor recycle stream” is meant herein an external piping loop whose contents are pumped from the reactor, through a heat exchanger, and back into the reactor. The reaction of the residual monomer is initiated by use of a reducing agent and an oxidizing agent. The oxidizing and reducing agents are added to the emulsion polymer by feeding them to the process side of a heat exchanger through which an emulsion polymer stream is flowing. By “process side” is meant herein the portion of the heat exchanger through which the material being processed flows. By “cooling side” is meant herein the portion of the heat exchanger through which the cooling material flows. The oxidizing agent and reducing agent are added simultaneously to different locations on the process side of the heat exchanger. By “different points in the heat exchanger” is meant herein that one agent is added to the inlet of the heat exchanger, while the other is added at the outlet of the heat exchanger. Alternatively, the reducing agent is added at the inlet of the heat exchanger and the oxidizing agent is added at the outlet of the heat exchanger, or preferably, the oxidizing agent is added at the inlet of the heat exchanger and the reducing agent is added at the outlet of the heat exchanger. The emulsion polymer stream containing the oxidizing and reducing agents is returned to the reactor, where the reaction is fully or partially completed. By “fully completed” is meant herein that the polymerization is continued until the residual monomer has reached a desired level of conversion, such as at least 95%, preferably at least 98%, and more preferably at least 99.5% of the monomer has been converted to polymer, and the ratio of solids to water is 80:20 to 20:80. By “solids”, is meant herein a composition including polymer, and solid fragments from surfactant, catalyst, activator or any other nonvolatile materials used in the polymerization reaction. By “partially completed” is meant herein that the amount of polymerization of the residual monomer is limited by the simultaneous addition of only 10% to 65% by weight of the reducing agent, and 10% to 65% by weight of the oxidizing agent to different locations on the process side of the heat exchanger in the recycle stream. The polymer emulsion is then transferred to at least one separate vessel for further processing, freeing up the reactor. The at least one separate vessel is equipped with means for providing agitation of the vessel contents. Optionally, during the transfer to the at least one separate vessel, the polymer emulsion is further cooled by an in-line heat exchanger. Optionally, the transfer is followed by, or performed at the same time as, the addition of additives, such as, for example, neutralizers, biocides, thickeners or rheology modifiers, tackifiers, emulsifiers, buffers, humectants, wetting agents, plasticizers, antifoaming agents, colorants, waxes, anti-oxidants, and coalescing agents to the at least one separate vessel. When the polymerization reaction has been only partially completed in the reactor, the addition of additives to the at least one separate vessel is performed either after or simultaneously with the addition of the remaining 35% to 90% of the reducing agent and the remaining 35% to 90% of the oxidizing agent. The reducing and oxidizing agents are added to the polymer emulsion by feeding them directly to the at least one separate vessel, or alternatively, they are simultaneously fed to different points on the process side of a heat exchanger in the reactor discharge stream. The addition of the remaining reducing and oxidizing agents results in the completion of the polymerization reaction.

The addition of the reducing and oxidizing agents to different locations on the process side of the heat exchanger results in a reduction in cycle time. Under conventional practice, reducing and oxidizing agents are typically separately added directly to the reactor. The reason for not simultaneously adding the redox agents to the reactor is that this results in a low chasing efficiency, and could lead to a runaway reaction. By “chasing efficiency” is meant herein the degree of efficacy with which the oxidizing and reducing agents cause the polymerization of the residual monomer. The need for separate addition of the oxidizing and reducing agents directly to the reactor results in long cycle times because the first agent added must be well mixed with the emulsion polymer before addition of the second agent. Such mixing cannot be achieved within a short period of time due to the large size of the reactor, the high viscosity of the emulsion polymer therein, and the small quantities of reducing and oxidizing agent needed to reduce residual monomer levels in the emulsion polymer. When the oxidizing and reducing agents are simultaneously fed to different locations on the process side a heat exchanger, the heat exchanger acts as a means for both cooling and mixing. As result the redox agent fed to the inlet of the heat exchanger is both cooled, and well mixed with the emulsion polymer stream before it reaches the outlet of the heat exchanger, where the second redox agent is fed.

In a different embodiment of the invention, the emulsion polymer is prepared by a semi-continuous process. In this embodiment, the supply of the materials used in the polymerization is optionally continued until the reactor is full, at which time the reactor feeds are stopped, and a portion of the reactor mixture is removed from the reactor, and transferred to at least one separate vessel, and thereupon the feeds to the reactor are resumed. Alternatively, the supply of the materials used in the polymerization is continued until the reactor is up to 95% full, while a continuous stream of the reactor mixture is simultaneously removed from the reactor and transferred to at least one separate vessel. In both cases, the emulsion polymer is optionally cooled by at least one heat exchanger in the transfer line prior to entering the at least one separate vessel. The at least one separate vessel is equipped with means for providing agitation of the vessel contents. The supply to the reactor of materials used in the semi-continuous polymerization process is stopped when the total supply is at least 1.05 reactor volumes and less than 6 reactor volumes, preferably at least 1.2 and less than 3 reactor volumes, and most preferably at least 1.4 and less than 2 reactor volumes. Once the supply of the reaction materials has ended, the reaction of the residual monomer is initiated by the addition of 10% to 65% of the reducing agent and 10% to 65% of the oxidizing agent to the emulsion polymer in the reactor. The reducing and oxidizing agents are fed directly to the reactor, or preferably, they are simultaneously fed to different locations on the process side of a heat exchanger in the reactor recyle loop. The reactor contents are then transferred to at least one separate vessel for further processing. Optionally, during this transfer, the emulsion polymer is further cooled by a heat exchanger. Optionally, the transfer of the emulsion polymer is followed by, or performed at the same time as, the addition of additives. The reaction of the remaining residual monomer is initiated in the at least one separate vessel by the addition of the remaining 35% to 90% of the reducing agent and the remaining 35% to 90% of the oxidizing agent to the at least one separate vessel. The reducing and oxidizing agents are fed directly to the at least one separate vessel, or preferably, they are simultaneously fed to different locations on the process side of a heat exchanger in the transfer line from the reactor to the at least one separate vessel.

In all embodiments of the invention which include the use of a heat exchanger, whether in the reactor recycle loop, or in the reactor discharge stream, suitable heat exchangers include, for example, shell and tube, plate and frame, plate and fin and spiral heat exchangers. Plate and frame heat exchangers are preferred.

In those embodiments of the invention where the oxidizing and reducing agents are fed to different locations on the process side of a heat exchanger in the reactor discharge stream, the polymer flow through the piping lines containing the heat exchanger may be limited by the capacity of the heat exchanger. To overcome these capacity limitations, the reactor discharge stream is optionally split upon exiting the reactor, with the first line being pumped through the heat exchanger to the at least one separate vessel, the second line bypassing the heat exchanger to go directly to the at least one separate vessel, and the contents of the two lines being mixed in the at least one separate vessel. Alternatively, the reactor discharge stream optionally flows through more than one heat exchanger.

The following examples are presented to illustrate the invention.

### EXAMPLE 1

A batch of butyl acrylate/methyl methacrylate emulsion polymer is prepared in a 2430 liter stainless steel vented reactor. The monomers (962 kg) are premixed with water (1035 kg) and surfactants (5.4 kg) in a monomer emulsion tank. 345 kg of hot water (90° C. to 99° C.) are added to the reactor. While the hot water is being added, the reactor vent is opened. After the hot water is added, ammonia persulfate and other additives are added to the reactor and the reactor vent line is closed. The reactor vent pressure (operating pressure) automatic controller setpoint is set to 40 psig. The monomer emulsion is fed over a two and one half hour period. Throughout the reaction the reactor is maintained at 83° C. The reaction temperature is maintained by an external Alpha Laval plate and frame heat exchanger.

The Alfa Laval heat exchanger is used to control the reaction temperature. The reactor jacket is not used. A reactor temperature controller manipulates a Wilden diaphragm pump to adjust the emulsion polymer flow rate through the heat exchanger. When the reaction temperature is above the desired set point the controller increases the pump setting and increases the emulsion polymer flow rate through the heat exchanger.

At end of feeds, the concentration of VOCs, including unreacted monomer, is 6000 ppm. A 16 liter charge of promotor solution is added into the reactor and is mixed for 5 minutes. The emulsion polymer is discharged through the heat exchanger and is directed to a 3600 1 separate vessel equipped with an agitator. The flow rate of emulsion polymer is approximately 58.7 kg/min. In the mean while, teritary butyl hydroperoxide (TBHP) solution (1.4 kg of TBHP premixed with 9.71 of water) is continuously added at the inlet of the heat exchanger at the rate of approximately 278.2 gram per minute. At the same time, activator solution (1.4 kg of isoascorbic acid premixes with 27.81 of water) is continuously added at the exit of heat exchanger at the rate of approximately 730.3 g per minute. The outlet stream of the heat exchanger passes through a pump, and enters the separate vessel. The outlet stream from the heat exchanger has a temperature lower than 60° C. After the completion of transfer of latex into the separate vessel, the emulsion polymer VOC concentration is 1200 ppm.

### COMPARATIVE EXAMPLE C2

Example 1 is repeated, except that both the TBHP solution and the activator solution are fed to the inlet of the heat exchanger. After the completion of transfer of emulsion polymer into the separate vessel, the emulsion polymer VOC concentration in the separate vessel is 4000 ppm.

### COMPARATIVE EXAMPLE C3

Example 1 is repeated, except that both the TBHP solution and the activator solution are fed to the outlet side of the heat exchanger. After the completion of transfer of emulsion polymer into the separate vessel the emulsion polymer VOC concentration in the separate vessel is 2000 ppm.

What is claimed is:

1. A method of preparing a polymer containing low residual monomer levels, comprising:
(i) preparing an emulsion polymer having one or more modes, and containing residual monomer;
(ii) providing a heat exchanger having a process side and a cooling side;
(iii) flowing at least a portion of said emulsion polymer through said process side of said heat exchanger;
(iv) initiating the polymerization of said residual monomer by simultaneously feeding an oxidizing agent and a reducing agent to different locations on said process side of said heat exchanger; and
(v) completing said polymerization reaction to produce an emulsion polymer having a reduced residual monomer level.

2. The method according to claim 1, wherein said emulsion polymer is prepared by a process selected from the group consisting of a batch process, and a semi-continuous process.

3. The method according to claim 1, wherein said heat exchanger is located in a location selected from the group consisting of a reactor recycle line, and a reactor discharge line.

4. The method according to claim 1, wherein said heat exchanger is a plate and frame heat exchanger.

5. The method according to claim 1, wherein said oxidizing agent is fed to the inlet of the process side of said heat exchanger, and said reducing agent is fed to the outlet of the process side of said heat exchanger.

6. The method according to claim 1, wherein said reducing agent is fed to the inlet of the process side of said heat exchanger, and said oxidizing agent is fed to the outlet of the process side of said heat exchanger

7. The method according to claim 1, wherein up to 99.5% of said residual monomer is reacted to form said emulsion polymer.

8. The method according to claim 1, wherein said completion of said polymerization reaction is performed in at least one separate vessel.

9. The method according to claim 1, wherein from 35% to 90% by weight of said reducing agent and from 35% to 90% by weight of said oxidizing agent are added to at least one separate vessel.

10. The method according to claim 1, wherein said heat exchanger is located in a first reactor discharge stream;
wherein said portion of said emulsion polymer flows through the process side of said heat exchanger in said first reactor discharge stream; and
wherein a different portion of said emulsion polymer flows through at least one second reactor discharge stream, said at least one second reactor discharge stream optionally containing a different heat exchanger.
